(19) United States
(12) Patent Application Publication
(10) Pub. No.: US 2009/0164647 A1
(43) Pub. Date: Jun. 25, 2009

(54) INTERFACE APPARATUS, EXCHANGE APPARATUS EQUIPPED WITH THE INTERFACE APPARATUS AND CONTROL METHOD FOR USE IN THE INTERFACE APPARATUS

(75) Inventors: Ryo Araki, Tokyo (JP); Atsushi Yamazaki, Hachioji-shi (JP); Shuichi Sato, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/263,132

(22) Filed: Oct. 31, 2008

(30) Foreign Application Priority Data
Dec. 20, 2007 (JP) 2007-329072

(51) Int. Cl. G06F 15/16

(52) U.S. Cl. 709/228

(57) ABSTRACT

According to one embodiment, an interface apparatus includes a connector capable of connecting a plurality of SIP terminals and a SIP network to a port, a first processor which executes an exchange processing to the plurality of SIP terminals, a second processor which executes an exchange processing to the SIP network, a memory which stores a terminal ID for specifying each of the plurality of SIP terminals, and a sorting module configured to refer to a stored content of the memory based on sender identification information in a control signal relating to an exchange received by the connector, and sort the control signal to the first processor or the second processor based on a reference result of the memory.

### CROSS-REFERENCE TO RELATED APPLICATIONS

This application is based upon and claims the benefit of priority from Japanese Patent Application No. 2007-329072, filed Dec. 20, 2007, the entire contents of which are incorporated herein by reference.

### BACKGROUND

1. Field

One embodiment of the present invention relates to a session initiation protocol (SIP) trunk gateway apparatus, and more particularly to an interface apparatus capable of connecting both SIP terminals and a SIP network, and a control method for use in an exchange apparatus including this interface apparatus and the interface apparatus.

2. Description of the Related Art

Recently, an IP telephone system which exchanges images and sound in a form of packet data bi-directionally through an Internet protocol (IP) network has been beginning to prevail. This IP telephone system not only allows each main apparatus connected to the IP network to perform communication between extension numbers and make incoming and outgoing calls from/to an external line, but also allows the communication between extension numbers and the incoming and outgoing calls from/to an external line to be made between different main apparatuses. This IP telephone system widely uses the SIP as its protocol.

According to this system, the SIPURI (terminal ID) of a SIP terminal of each main apparatus is registered in a registration server of a service provider on the SIP network and when a call is made at the SIP terminal using the SIP network, the registration server authenticates the SIP terminal based on the registered SIPURI.

There has been proposed a technology relating to the above-described system in which a specialized SIP terminal acts as a main apparatus for standard SIP terminals while that SIP terminal itself serves as a client also (for example, Jpn. Pat. Appln. KOKAI Publication No. 2007-13304). This system does not need any main apparatus.

The main apparatus has separate IP ports for receiving a SIP message between the SIP terminal and the SIP network. Even according to the above-mentioned technology, the IP ports for receiving the SIP message are provided for the SIP terminal and the SIP network separately. In this case, there may occur a case where a widely recognized SIP default port number 5060 is not used, such as a case where the SIP terminal (hereinafter referred to as SIP server function) uses a port number 5060 and the IP network (hereinafter referred to as SIP client function) uses a port number 5062. As a result, setting of the SIP terminals and setting of network devices such as firewall and application layer gateway become complicated, thereby providing much inconvenience.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the Invention.

FIG. 1 is a block diagram showing an embodiment of the IP telephone system according to the present invention;

FIG. 2 is a diagram showing an example of a stored content of the SIP extension registration table shown in FIG. 1;

FIG. 3 is a sequence diagram for explaining a registration action of the SIP extension line of the embodiment;

FIG. 4 is a flow chart showing a procedure of the SIP server processing module at the time of registration of the embodiment;

FIG. 5 is a sequence diagram for explaining sort processing for SIP messages of the embodiment; and

FIG. 6 is a flow chart showing the procedure of a SIP client/server sorting module of the embodiment.

### DETAILED DESCRIPTION

Various embodiments according to the invention will be described hereinafter with reference to the accompanying drawings, in general, according to one embodiment of the invention, an interface apparatus comprising: a connector capable of connecting a plurality of session initiation protocol (SIP) terminals and a SIP network to a port, the SIP terminals including a communication function specified by SIP; a first processor which executes an exchange processing to the plurality of SIP terminals; a second processor which executes an exchange processing to the SIP network; a memory which stores a terminal ID for specifying each of the plurality of SIP terminals; and a sorting module configured to refer to a stored content of the memory based on sender identification information in a control signal relating to an exchange received by the connectors and sort the control signal to the first processor or the second processor based on a reference result of the memory.

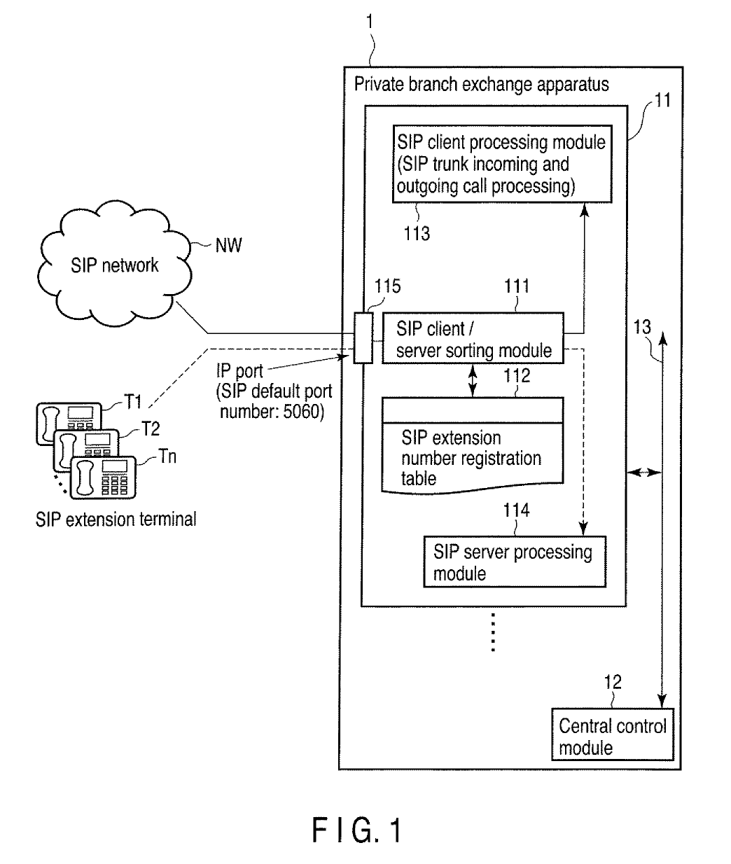

FIG. 1 is a block diagram showing an embodiment of an IP telephone system of the present invention and reference numeral 1 denotes a private branch exchange apparatus.

The private branch exchange apparatus 1 includes a plurality of interface modules 11 (only the interface module 12 is represented here for simplification of description) and a central control module 12, which are connected to each other through a control bus 13.

The interface module 11 is connected to a SIP network NW in order to execute a call establishment processing with respect to the SIP network NW under the control of the central control module 12. The interface module 11 contains a plurality of SIP extension terminals T1 to Tn (n is a natural number). The interface module 11 executes an interface operation of incoming and outgoing call processing for a plurality of the SIP extension terminals T1 to Tn. Further, the interface module 11 executes exchange of various kinds of control information relating to the interface operation to the plurality of the SIP extension terminals T1 to Tn with the central control module 12.

On the other hand, the central control module 12 has a control function for achieving an operation as the private branch exchange apparatus 1.

The interface module 11 of this embodiment includes a SIP client/server sorting module 11 (hereinafter referred to as sorting module 11), a SIP extension registration table 112, a SIP client processing module 113, a SIP server processing module 114 and an IP port 115 for receiving a SIP message.

The sorting module 111 refers to the SIP extension registration table 112 using a sender IP address contained in the SIP message received by the IP port 115 and executes sorting control for the SIP message to the SIP client processing module 113 or the SIP server processing module 114 based on a result of this reference. When it receives a SIP-register message (registration request message) from the SIP extension terminals T1 to Tn, the sorting module 111 transfers this SIP-register message to the SIP server processing module 114 unconditionally.

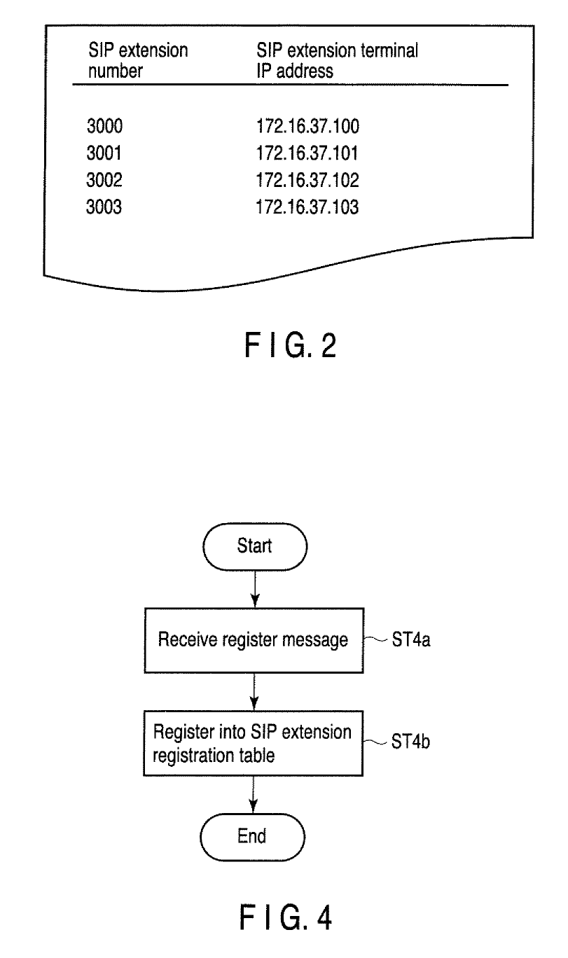

As shown in FIG. 2, the SIP extension registration table 112 has stored therein all information expressing the correlation between the SIP extension number of the SIP extension terminals T1 to Tn accommodated in the private branch exchange apparatus 1 and the SIP extension terminal IP address.

The SIP client processing module 113 executes an interface processing such as a call establishment processing with respect to the SIP network NW and exchanges the control information relating to this interface operation with the central control module 12.

The SIP server processing module 114 executes an interface operation such as the incoming and outgoing call processing to the plurality of the SIP extension terminals T1 to Tn and exchanges the control information relating to this interface operation with the central control module 12. Further, the SIP server processing module 114 executes a registration processing to the SIP extension registration table 112 when it receives the SIP-register message.

Next, a processing operation under the above-described configuration will be described.

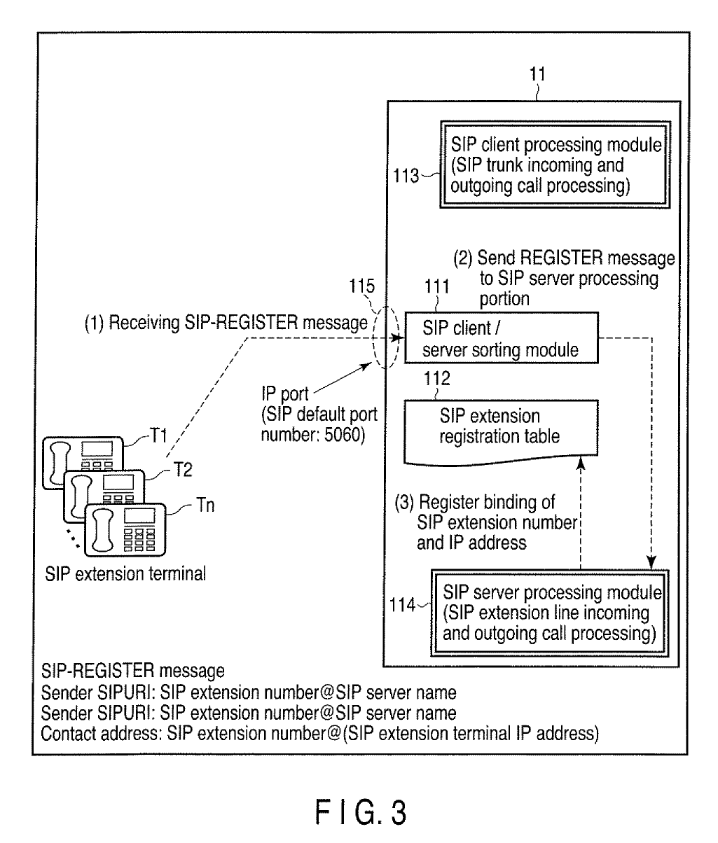

FIG. 3 is a sequence diagram for explaining the registration operation of the SIP extension line and FIG. 4 is a flow chart showing the procedure of the SIP server processing module 114 at the time of registration operation.

When the sorting module 111 receives the SIP-register message from the SIP extension terminals T1 to Tn (FIG. 3(1)), the sorting module 111 sorts the message to the SIP server processing module 114 unconditionally (FIG. 3(2)).

When the SIP server processing module 114 receives a SIP-register message (block ST4a), it extracts a SIP extension number and a SIP extension terminal SIP address from the contact address of the SIP-register message and registers this binding into the SIP extension registration table 112 (block ST4b).

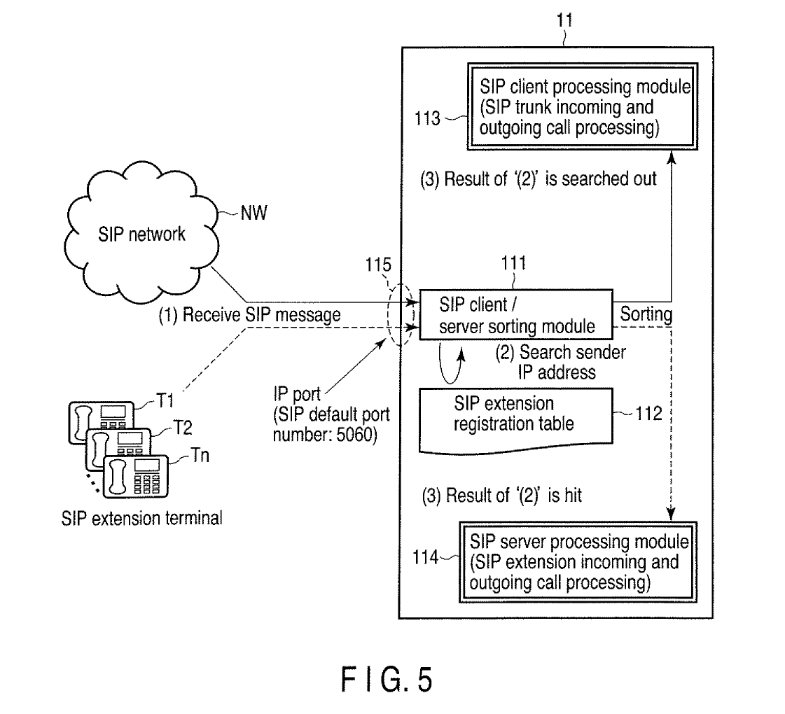

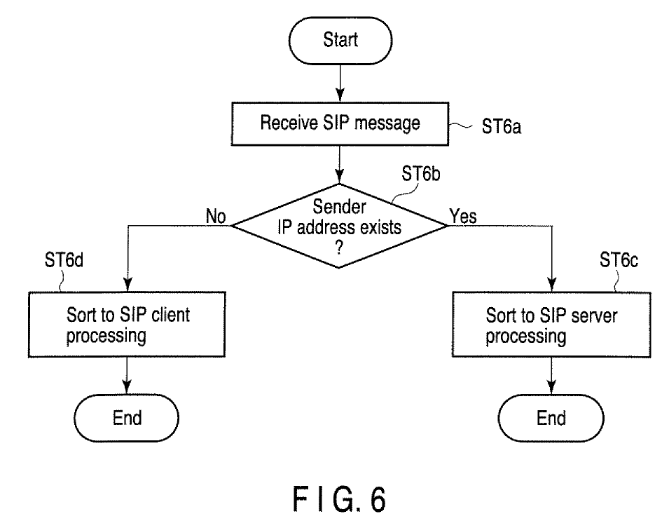

FIG. 5 is a sequence diagram for explaining the sorting processing for the SIP message and FIG. 6 is a flow chart showing the procedure of the sorting module 111 at the time of the SIP message sorting processing.

When the sorting module 111 receives a SIP message (WIG. 5(1), block ST6a), it searches the SIP extension registration table 112 with the sender IP address of the SIP message used as a key (FIG. 5(2), block ST6b). If the sender IP address is registered on the SIP extension registration table 112 (Yes), the sorting module 111 sorts the SIP message to the SIP server processing module 114 (block ST6c).

If the sender IP address is not registered on the SIP extension registration table 112 (No), the sorting module 111 sorts the SIP message to the SIP client processing module 113 (block ST6d).

As described above, in the interface module 11 according to the above-described embodiment, a plurality of the SIP extension terminals T1 to Tn and the SIP network NW are connected to the IP port 115. The interface module 11 includes the SIP client processing module 113 and the SIP server processing module 114 and further contains the SIP extension registration table 112 which has stored therein information expressing the correlation between the SIP extension number and the SIP extension terminal IP address of each of the plurality of accommodated SIP extension terminals T1 to Tn. When the interface module 11 receives a SIP message through the IP port 115, the sorting module 111 sorts the SIP message to the SIP client processing module 113 and the SIP server processing module 114 with a simple procedure using the sender IP address in the SIP message and the registration information of the SIP extension registration table 112.

Thus, by adopting the structure capable of receiving the SIP messages of different SIP services, namely, the SIP server function and the SIP client function, through the IP port 115, a network environment can be built up easily using only a widely known SIP default port number 5060.

It is only necessary to register only information expressing the correlation between the SIP extension number and the SIP extension terminal IP address of each of the plurality of the SIP extension terminals T1 to Tn accommodated in the private branch exchange apparatus 1 into the SIP extension registration table 112. Consequently, the storage capacity of the entire interface module 11 can be reduced largely, thereby leading to reduction of the circuit size of the interface module 11.

Further, according to this embodiment, even if a non-registered SIP extension terminal is connected to the IP port 115, the SIP extension number and the SIP extension terminal IP address of the non-registered SIP extension terminal can be automatically registered into the SIP extension registration table 112 without any manual operation by an operator of the private branch exchange apparatus 1.

The SIP extension terminal may be any terminal using wireless LAN or any soft phone set which is realized with software on a personal computer, as long as it has the communication function defined by SIP.

In the above embodiment, the example in which the private branch exchange apparatus 1 is equipped with the interface module 11 has been described. However, the interface module 11 may be provided on other electronic equipment.

Additionally, the configuration and type of the system, the configuration and type of the private branch exchange apparatus, the function of the interface module, the memory content of the SIP extension registration table, the control method for sorting of the SIP message to the SIP client processing module and SIP server processing module, the registration method of the non-registered SIP terminal to the SIP extension registration table and the like may be modified in various ways within a scope not departing from the gist of the present invention.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interface apparatus comprising:
a connector capable of connecting a plurality of session initiation protocol (SIP) terminals and a SIP network to a port, the SIP terminals including a communication function specified by SIP;
a first processor which executes an exchange processing to the plurality of SIP terminals;
a second processor which executes an exchange processing to the SIP network;
a memory which stores a terminal ID for specifying each of the plurality of SIP terminals; and
a sorting module configured to refer to a stored content of the memory based on sender identification information in a control signal relating to an exchange received by the connector, and sort the control signal to the first processor or the second processor based on a reference result of the memory.

2. The interface apparatus according to claim 1, further comprising a registering module configured to register the terminal ID for specifying the SIP terminal into the memory based on a registration request message arriving from the SIP terminal, when a SIP terminal not registered to the memory is connected to the connector.

3. An exchange apparatus comprising:
an interface apparatus which accommodates a plurality of session initiation protocol (SIP) terminals each including a communication function specified by SIP and is capable of connecting the SIP network; and
an exchange controller which makes the interface apparatus execute an exchange processing relating to said plurality of SIP terminals or the SIP network,
wherein the interface apparatus includes:
a connector which connects the plurality of SIP terminals and the SIP network to a port;
a first processor which executes an exchange processing to the plurality of SIP terminals;
a second processor which executes an exchange processing to The SIP network;
a memory which stores a terminal ID for specifying each of the plurality of SIP terminals; and
a sorting module configured to refer to a stored content of the memory based on sender identification information in a control signal relating to an exchange received by the connector, and sort the control signal to the first processor or the second processor based on a reference result of the memory.

4. The exchange apparatus according to claim 3, further comprising a registering module configured to register the terminal ID for specifying the SIP terminal into the memory based on a registration request message arriving from the SIP terminal, when a SIP terminal not registered to the memory is connected to the connector.

5. A control method for use in an interface apparatus capable of connecting a plurality of session initiation protocol (SIP) terminals a SIP network to a port, the SIP terminals including a communication function specified by SIP, the method comprising:
storing a terminal ID for specifying each of the plurality of SIP terminals connected to the interface apparatus in a memory;
referring to a stored content of the memory based on sender identification information in the control signal, when a control signal relating to an exchange arrives;
executing an exchange processing for the plurality or SIP terminals, when the sender identification information and the terminal ID in the memory agree with each other as a reference result of the memory; and
executing the exchange processing for the SIP network, when the sender identification information and the terminal ID in the memory do not agree with each other as a reference result of the memory.
